(19) United States
(12) Patent Application Publication
(10) Pub. No.: US 2026/0346697 A1
(43) Pub. Date: Nov. 5, 2026

(54) VEHICLE DRIVE SYSTEM WITH INTEGRATED NESTED DAMPER ASSEMBLY TO ROTOR ARCHITECTURE

(71) Applicant: GM GLOBAL TECHNOLOGY OPERATIONS LLC, Detroit, MI (US)

(72) Inventors: Chi Teck Lee, Novi, MI (US); Favian Zavala, Northville, MI (US); Matthew J. Laskaska, Essexville, MI (US)

(73) Assignee: GM GLOBAL TECHNOLOGY OPERATIONS LLC, Detroit, MI (US)

(21) Appl. No.: 19/198,188

(22) Filed: May 5, 2025

(51) Int. Cl. B60K 6/46; B60K 6/26; B60K 6/365

(52) U.S. Cl. CPC B60K 6/46; B60K 6/26; B60K 6/365; B60K 2006/262

(57) ABSTRACT

An electric generator includes an input shaft, a housing assembly, a stator, a rotor assembly, and a nested damper assembly arranged concentric to the input shaft within the housing assembly of the electric generator. The housing assembly includes a case portion and a housing portion both of which are arranged concentric to the input shaft. The electric generator includes an inverter, which may be arranged adjacent to or spaced a distance away from the housing assembly. The electric generator may also include a simple planetary gear set or a compound planetary gear set arranged within the housing assembly.

### INTRODUCTION

The concepts described herein relate generally to vehicle drive systems. More specifically, aspects of this disclosure relate to internal combustion (IC) engine-driven vehicle drive systems with integrated nested damper assembly to rotor architecture for hybrid electric vehicles (HEV), plug-in hybrid vehicle (PHEV), or other mobile platform powered by an electrified vehicle drive system.

A vehicle drive system for an HEV, PHEV, and the like includes an electric generator arranged between an IC engine and an electric machine. The electric generator is driven by the IC engine. A damper is arranged between the IC engine and the electric generator to mitigate torsional vibration and regulate torque between the IC engine and the electric generator. The damper also helps reduce noise, vibration, and harshness, improving the driving experience and extending the lifespan of the vehicle drive system.

Dampers are arranged external to both the IC engine and the electric generator adding both weight and packaging complexity to the vehicle drive system.

### SUMMARY

In view of the above discussion, it is useful to develop a vehicle drive system with an integrated, nested damper assembly, in which a damper is integrated within the electric generator, nested within the electric generator rotor assembly.

The concepts disclosed herein relate to a vehicle drive system with an integrated, nested damper system, in which a damper is integrated within an electric generator, nested within an electric generator rotor assembly. Such a system may be used in a vehicle having an electrified propulsion system, for example, but not limited to, a motor vehicle having an electrified powertrain, drive system, or propulsion system, e.g., an electric vehicle (EV) or plug-in hybrid vehicle (PHEV), or another mobile platform, which may be powered by an electric propulsion system, to reduce mass and complexity of the electric generator.

According to one aspect of the disclosure, an electric generator may include an input shaft, a housing assembly having a case portion and a housing portion, a nested damper assembly, which may be arranged within the housing assembly, and an inverter, which may be configured as an integrated inverter.

The case portion may be arranged adjacent to the housing portion. The case portion, the housing portion, and the nested damper assembly may each be arranged concentric to the input shaft.

A shaft seal may be arranged concentric to the input shaft between the input shaft and the case portion of the housing assembly of the electric generator.

An engine flange may be arranged adjacent to a first face of the case portion of the housing assembly, and may be concentric to the input shaft.

A first hub may be arranged concentric to the input shaft, and a second hub may be arranged concentric to the input shaft. The nested damper assembly may be arranged between the first hub and the second hub, such that a first side of the first hub may be arranged adjacent to the case portion of the housing assembly of the electric generator, and a second side of the first hub may be arranged adjacent to a first side of the nested damper assembly, and a first side of the second hub may be arranged adjacent to the housing portion of the housing assembly of the electric generator, and a second side of the second hub may be arranged adjacent to a second side of the nested damper assembly.

A stator may be arranged concentric to the input shaft, between the housing assembly and the nested damper assembly.

A rotor assembly may be arranged concentric to the input shaft, and located between the housing assembly and the nested damper assembly.

A resolver ring may be arranged concentric to the input shaft, and may be adjacent to a resolver. The resolver ring and resolver may be arranged between the second hub and the housing portion of the housing assembly.

An alternating current (AC) grounding brush may be arranged concentric to the input shaft, and may be adjacent to second hub opposite the resolver ring. The AC grounding brush may be placed at an interface between a rotor assembly and a ground.

Deep groove ball bearings may be arranged between the first hub and the case portion of the housing assembly, and the second hub and the housing portion of the housing assembly respectively.

The rotor assembly may include spline connections that may connect the AC grounding brush and the deep groove ball bearings to the housing assembly directing reacting loads from the IC engine to the housing assembly.

The inverter may be configured as an integrated inverter. That is, the inverter may be arranged adjacent to the housing assembly of the electric generator, and may be mechanically connected to the housing assembly of the electric generator, via a plurality of mechanical fasteners.

According to another aspect of the disclosure, an electric generator may include an input shaft, a housing assembly having a case portion and a housing portion, a nested damper assembly, which may be arranged within the housing assembly and an inverter, which may be configured as a remote inverter.

The case portion may be arranged adjacent to the housing portion. The case portion, the housing portion, and the nested damper assembly each may be arranged concentric to the input shaft.

A shaft seal may be arranged concentric to the input shaft between the input shaft and the case portion of the housing assembly of the electric generator.

An engine flange may be arranged adjacent to a first face of the case portion of the housing assembly, and may be concentric to the input shaft.

A first hub may be arranged concentric to the input shaft, and a second hub may be arranged concentric to the input shaft. The nested damper assembly may be arranged between the first hub and the second hub, such that a first side of the first hub may be arranged adjacent to the case portion of the housing assembly of the electric generator, and a second side of the first hub may be arranged adjacent to a first side of the nested damper assembly, and a first side of the second hub may be arranged adjacent to the housing portion of the housing assembly of the electric generator, and a second side of the second hub may be arranged adjacent to a second side of the nested damper assembly.

A stator may be arranged concentric to the input shaft, between the housing assembly and the nested damper assembly.

A rotor assembly may be arranged concentric to the input shaft, and located between the housing assembly and the nested damper assembly.

A resolver ring may be arranged concentric to the input shaft, and adjacent to a resolver. The resolver ring and resolver may be arranged between the second hub and the housing portion of the housing assembly.

An alternating current (AC) grounding brush may be arranged concentric to the input shaft, adjacent to second hub opposite the resolver ring. The AC grounding brush may be placed at an interface between the rotor assembly and a ground.

Deep groove ball bearings may be arranged between the first hub and the case portion of the housing assembly, and the second hub and the housing portion of the housing assembly respectively.

The rotor assembly may include spline connections that connect the AC grounding brush and the deep groove ball bearings to the housing assembly directing reacting loads from the internal combustion (IC) engine to the housing assembly.

The inverter may be configured as a remote inverter. That is, the inverter may be located a distance D away from the housing assembly of the electric generator, and electrically connected to the housing assembly of the electric generator via alternating current (AC) cabling.

According to one aspect of the disclosure, an electric generator may include an input shaft, a housing assembly having a case portion and a housing portion, a nested damper assembly, which may be arranged within the housing assembly, and an inverter, which may be configured as a remote inverter.

The case portion may be arranged adjacent to the housing portion. The case portion, the housing portion, and the nested damper assembly each may be arranged concentric to the input shaft.

A shaft seal may be arranged concentric to the input shaft between the input shaft and the case portion of the housing assembly of the electric generator.

An engine flange may be arranged adjacent to a first face of the case portion of the housing assembly, and concentric to the input shaft.

A planetary gear set, which may be configured as a simple planetary gear set, may be arranged concentric to the input shaft. The planetary gear set may include a ring gear, which may be arranged concentric to the input shaft, a planetary carrier, which may be arranged concentric to the input shaft, a plurality of planet gears, which may be arranged within the planetary carrier, a grounded sun gear, which may be arranged within the plurality of planet gears, and a sun gear flange, which may be arranged adjacent to the housing portion of the housing assembly of the electric generator.

A first side of the planetary gear set may be arranged adjacent to the nested damper assembly, and a second side of the planetary gear set, which may be arranged adjacent to the housing portion of the housing assembly of the electric generator.

A stator may be arranged concentric to the input shaft, between the housing assembly and the planetary gear set.

A rotor assembly may be arranged concentric to the input shaft, and located between the housing assembly and the planetary gear set.

A resolver ring may be arranged concentric to the input shaft, and adjacent to a resolver. The resolver ring and resolver may be arranged between the sun gear flange and the housing portion of the housing assembly.

An alternating current (AC) grounding brush may be arranged concentric to the input shaft, adjacent to the sun gear flange opposite the resolver ring. The AC grounding brush may be placed at an interface between the rotor assembly and a ground and/or the grounded sun gear.

First and second thrust bearings may be arranged between the case portion of the housing assembly and the nested damper assembly, and the sun gear flange and the housing portion of the housing assembly respectively.

A thrust washer may be arranged concentric to the input shaft, and between the plurality of planet gears and the sun gear flange. The thrust washer may be arranged adjacent to the first thrust bearing or the second thrust bearing as a backing element that acts to insulate the first or second thrust bearing.

The rotor assembly may include spline connections that may connect the AC grounding brush and the first and second thrust bearings to the housing assembly directing reacting loads from the IC engine to the housing assembly.

The inverter may be configured as a remote inverter. That is, the inverter may be located a distance D away from the housing assembly of the electric generator, and may be electrically connected to the housing assembly of the electric generator via alternating current (AC) cabling.

According to one aspect of the disclosure, an electric generator may include an input shaft, a housing assembly having a case portion and a housing portion, a nested damper assembly, which may be arranged within the housing assembly, and an inverter, which may be configured as a remote inverter.

The case portion may be arranged adjacent to the housing portion. The case portion, the housing portion, and the nested damper assembly each may be arranged concentric to the input shaft.

A shaft seal may be arranged concentric to the input shaft between the input shaft and the case portion of the housing assembly of the electric generator.

An engine flange may be arranged adjacent to a first face of the case portion of the housing assembly, and may be concentric to the input shaft.

A planetary gear set, which may be configured as a compound planetary gear set, may be arranged concentric to the input shaft. The planetary gear set may include a planetary carrier, which may be arranged concentric to the input shaft, a first plurality of planet gears and a second plurality of planet gears, which may be arranged within the planetary carrier, a grounded sun gear, a sun gear, and a sun gear flange, which may be arranged adjacent to the housing portion of the housing assembly of the electric generator.

The sun gear may be arranged concentric with and adjacent to the grounded sun gear in a meshed configuration.

The first plurality of planet gears may be arranged adjacent to the grounded sun gear in a meshed configuration, and the second plurality of planet gears may be arranged adjacent to the sun gear in a meshed configuration.

A first side of the planetary gear set may be arranged adjacent to the nested damper assembly, and a second side of the planetary gear set may be arranged adjacent to the sun gear flange, which may be arranged adjacent to the housing portion of the housing assembly of the electric generator.

A stator may be arranged concentric to the input shaft, between the housing assembly and the planetary gear set.

A rotor assembly may be arranged concentric to the input shaft, and located between the housing assembly and the planetary gear set.

A resolver ring may be arranged concentric to the input shaft, and adjacent to a resolver. The resolver ring and resolver may be arranged between the sun gear flange and the housing portion of the housing assembly.

An alternating current (AC) grounding brush may be arranged concentric to the input shaft, adjacent to the sun gear flange opposite the resolver ring. The AC grounding brush may be placed at an interface between the rotor assembly and a ground and/or the grounded sun gear.

A first plurality of thrust bearings may be arranged between the case portion of the housing assembly and the first side of the nested damper assembly, and the second side of the nested damper assembly and the grounded sun gear.

A second plurality of thrust bearings may be arranged at opposing sides of a sun gear.

A thrust washer may be arranged concentric to the input shaft, and between the first plurality of planet gears and the sun gear flange, and the second plurality of planet gears and the sun gear flange. The thrust washer may be arranged adjacent to one of the second plurality of thrust bearings as a backing element that acts to insulate the thrust bearing.

The rotor assembly may include spline connections that may connect the AC grounding brush and the first and second plurality of thrust bearings to the housing assembly directing reacting loads from the internal combustion (IC) engine to the housing assembly.

The inverter may be configured as a remote inverter. That is, the inverter may be located a distance D away from the housing assembly of the electric generator, and may be electrically connected to the housing assembly of the electric generator via alternating current (AC) cabling.

Power from the IC engine may be output as engine torque to the nested damper assembly, which may transfer the engine torque to the planetary carrier. The grounded sun gear may react torque from the second plurality of planet gears, which may mesh with the first plurality of planet gears, to transfer torque from to the sun gear, which may transfer torque to the rotor assembly through the spline connections.

An electrified drive system and a vehicle, which may include the electric generator discussed above, are also disclosed.

By including the nested damper assembly into the electric generator, mass and packaging of the electric generator are optimized.

By including a simple planetary gear set in addition to the nested damper assembly, the electric generator is operable to increase a speed ratio from the planetary carrier to the ring gear, while optimizing mass and packaging of the electric generator.

By including a compound planetary gear set in addition to the nested damper assembly, the electric generator is operable to increase a speed of the rotor to facilitate a speed match between the internal combustion (IC) engine and the electric machine, while optimizing mass and packaging of the electric generator.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

The accompanying drawings, which are incorporated into and constitute a part of this specification, illustrate implementations of the disclosure which, taken together with the description, serve to explain the principles of the disclosure.

FIG. 1 is a schematic illustration of an electrified drive system.

FIG. 2 is a schematic illustration of an electric generator for an electrified drive system, the electric generator including a nested damper assembly and having an integrated inverter in accordance with one aspect of the present disclosure.

FIG. 2A is a schematic illustration of an electric generator for an electrified drive system, the electric generator including a nested damper assembly and having an integrated inverter, in accordance with one aspect of the present disclosure.

FIG. 3 is a schematic illustration of an electric generator for an electrified drive system, the electric generator including a nested damper assembly and a simple planetary gear set, and having an integrated inverter, in accordance with one aspect of the present disclosure.

FIG. 3A is a schematic illustration of an electric generator for an electrified drive system, the electric generator including a nested damper assembly and a compound planetary gear set, and having a remote inverter, in accordance with one aspect of the present disclosure.

The appended drawings are not necessarily to scale, and may present a somewhat simplified representation of various preferred features of the present disclosure as disclosed herein, including, for example, specific dimensions, orientations, locations, and shapes. Details adjacent to such features will be determined in part by the particular intended application and use environment.

### DETAILED DESCRIPTION

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including,” “containing,” “comprising,” “having,” and the like shall mean “including without limitation.” Moreover, words of approximation such as “about,” “almost,” “substantially,” “generally,” “approximately,” etc., may be used herein in the sense of “at, near, or nearly at,” or “within 0-5% of,” or “within acceptable manufacturing tolerances,” or logical combinations thereof.

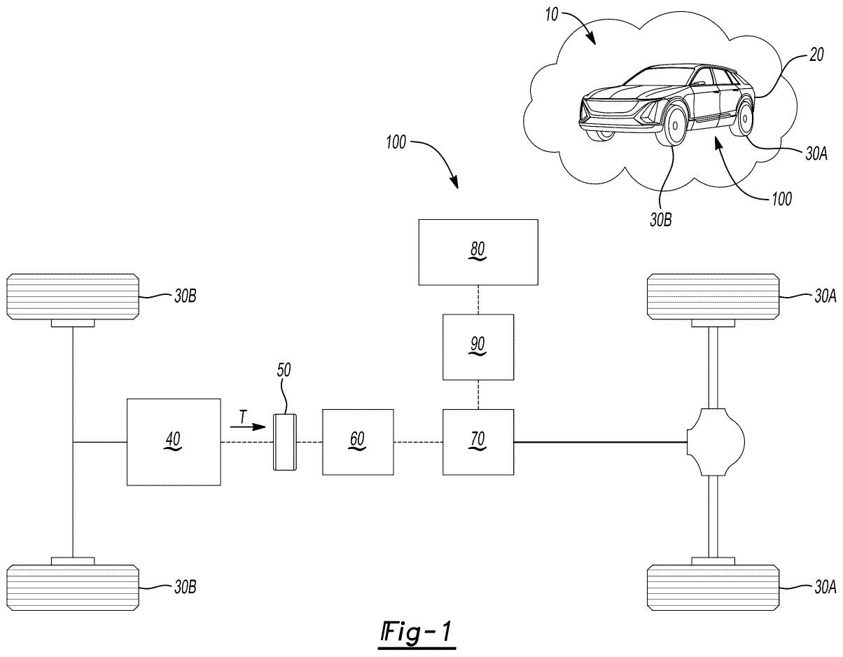

Referring to the drawings, wherein like reference numbers refer to the same or like components in the several Figures, FIG. 1 schematically illustrates an electrified drive system 100 that is composed of an internal combustion (IC) engine 40, a damper 50, an electric generator 60, and an electric machine 70, and a battery energy storage system (BESS) 80, the operations of which are controlled by a controller 90.

The electrified drive system 100 is disposed on an electrified vehicle, schematically illustrated at 10, and capable of generating tractive torque for vehicle propulsion. When disposed on the electrified vehicle 10, the electrified vehicle 10 may include, but not be limited to a mobile platform in the form of a commercial vehicle, industrial vehicle, agricultural vehicle, passenger vehicle, aircraft, watercraft, train, all-terrain vehicle, personal movement apparatus, robot and the like to accomplish the purposes of this disclosure. Alternatively, the electric drive system 100 may be an element of a stationary system.

The electrified vehicle 10 includes a vehicle body 20, the electrified drive system 100 arranged adjacent to the vehicle body 20, and wheel assemblies 30A, 30B.

The IC engine 40 outputs power to the damper 50, which transfers dampened torque to the electric generator 60, which provides the dampened torque to the electric machine 70, which is configured to generate and transfer torque to one or more of the wheel assemblies 30A and/or 30B to effect work. The controller 90 is configured to execute control routines to control and manage operation of the electrified drive system 100.

The controller 90 may be embodied as one or more digital computing devices and may include one or more processors and memory. Control routines may be stored as an executable instruction set in the memory and executed by one of the processors of the controller 90.

The term “controller” and related terms such as microcontroller, control module, module, control, control unit, processor and similar terms refer to one or various combinations of Application Specific Integrated Circuit(s) (ASIC), Field-Programmable Gate Array (FPGA), electronic circuit(s), central processing unit(s), e.g., microprocessor(s) and associated memory component(s) in the form of transitory and/or non-transitory memory component(s) and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning and buffer circuitry and other components that may be accessed by one or more processors to provide a described functionality. Input/output circuit(s) and devices include analog/digital inverters and related devices that monitor inputs from sensors, with such inputs monitored at a preset sampling frequency or in response to a triggering event. Software, firmware, programs, instructions, control routines, code, algorithms and similar terms mean controller-executable instruction sets including calibrations and look-up tables.

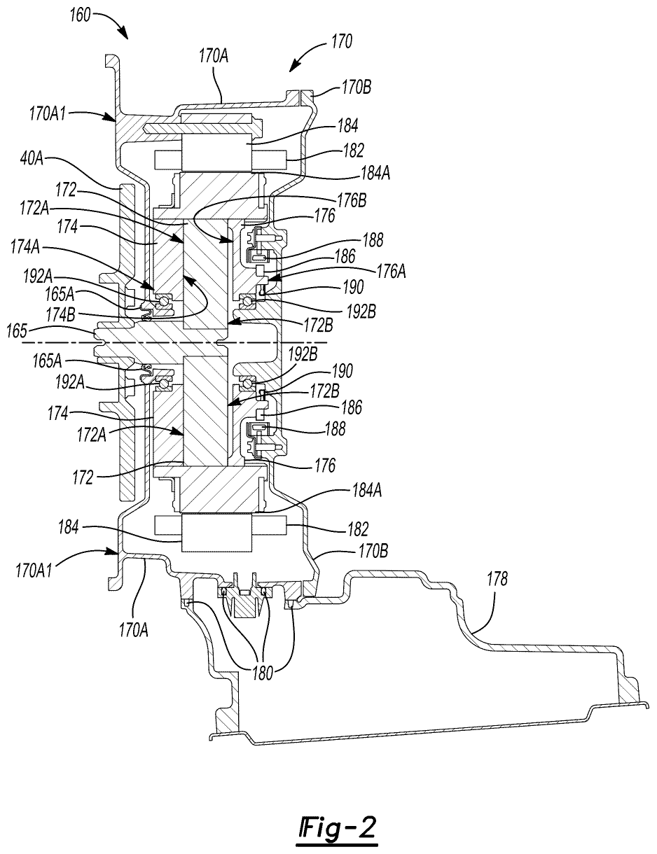

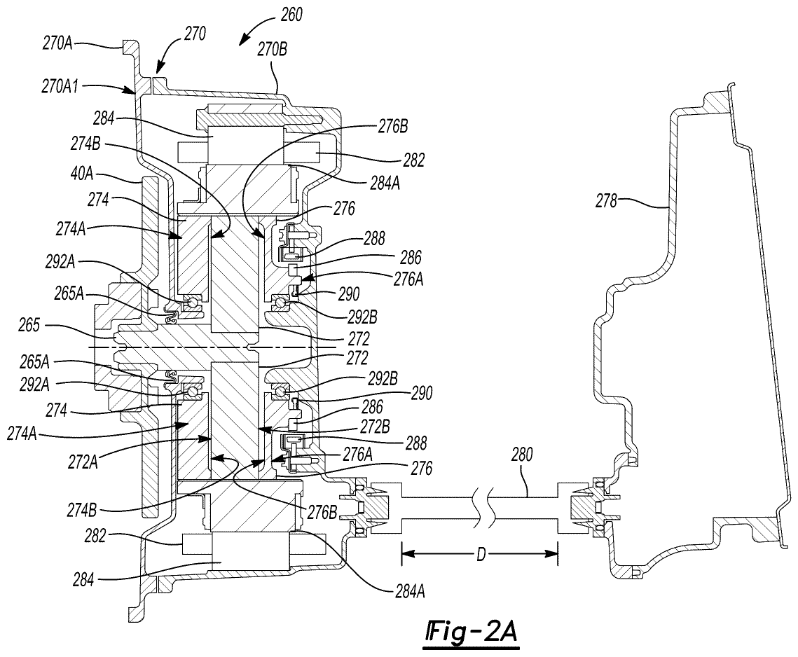

According to one aspect of the disclosure, schematically illustrated in FIG. 2, an electric generator 160 includes an input shaft 165, a housing assembly 170 having a case portion 170A and a housing portion 170B, a nested damper assembly 172 arranged within the housing assembly 170, and an inverter 178, which is configured as an integrated inverter.

The case portion 170A is arranged adjacent to the housing portion 170B. The case portion 170A, the housing portion 170B, and the nested damper assembly 172 are each arranged concentric to the input shaft 165.

A shaft seal 165A is arranged concentric to the input shaft 165 between the input shaft 165 and the case portion 170A of the housing assembly 170 of the electric generator 160.

An engine flange 40A is arranged adjacent to a first face 170A1 of the case portion 170A of the housing assembly 170, and concentric to the input shaft 165.

A first hub 174 is arranged concentric to the input shaft 165, and a second hub 176 is arranged concentric to the input shaft 165. The nested damper assembly 172 is arranged between the first hub 174 and the second hub 176, such that a first side 174A of the first hub 174 is arranged adjacent to the case portion 170A of the housing assembly 170 of the electric generator 160, and a second side 174B of the first hub 174 is arranged adjacent to a first side 172A of the nested damper assembly 172, and a first side 176A of the second hub 176 is arranged adjacent to the housing portion 170B of the housing assembly 170 of the electric generator 160, and a second side 176B of the second hub 176 is arranged adjacent to a second side 172B of the nested damper assembly 172.

A stator 182 is arranged concentric to the input shaft 165, between the housing assembly 170 and the nested damper assembly 172.

A rotor assembly 184 is arranged concentric to the input shaft 165, and located between the housing assembly 170 and the nested damper assembly 172.

A resolver ring 186 is arranged concentric to the input shaft 165, and adjacent to a resolver 188. The resolver ring 186 and resolver 188 are arranged between the second hub 176 and the housing portion 170B of the housing assembly 170.

An alternating current (AC) grounding brush 190 is arranged concentric to the input shaft 165, adjacent to second hub 176 opposite the resolver ring 186. The AC grounding brush 190 is placed at an interface between a rotor assembly 184 and a ground (not shown).

Deep groove ball bearings 192A, 192B are arranged between the first hub 174 and the case portion 170A of the housing assembly 170, and the second hub 176 and the housing portion 170B of the housing assembly 170 respectively.

The rotor assembly 184 includes spline connections 184A that connect the AC grounding brush 190 and the deep groove ball bearings 192A, 192B to the housing assembly 170 directing reacting loads from the IC engine 40 to the housing assembly 170.

As illustrated in FIG. 2, the inverter 178 is configured as an integrated inverter. That is, the inverter 178 is arranged adjacent to the housing assembly 170 of the electric generator 160, and mechanically connected to the housing assembly 170 of the electric generator 160, via a plurality of mechanical fasteners, schematically illustrated at 180.

According to another aspect of the disclosure, as illustrated in FIG. 2A, an electric generator 260 includes an input shaft 265, a housing assembly 270 having a case portion 270A and a housing portion 270B, a nested damper assembly 272 arranged within the housing assembly 270 and an inverter 278, which is configured as a remote inverter.

The case portion 270A is arranged adjacent to the housing portion 270B. The case portion 270A, the housing portion 270B, and the nested damper assembly 272 are each arranged concentric to the input shaft 265.

A shaft seal 265A is arranged concentric to the input shaft 265 between the input shaft 265 and the case portion 270A of the housing assembly 270 of the electric generator 260.

An engine flange 40A is arranged adjacent to a first face 270A1 of the case portion 270A of the housing assembly 270, and concentric to the input shaft 265.

A first hub 274 is arranged concentric to the input shaft 265, and a second hub 276 is arranged concentric to the input shaft 265. The nested damper assembly 272 is arranged between the first hub 274 and the second hub 276, such that a first side 274A of the first hub 274 is arranged adjacent to the case portion 270A of the housing assembly 270 of the electric generator 260, and a second side 274B of the first hub 274 is arranged adjacent to a first side 272A of the nested damper assembly 272, and a first side 276A of the second hub 276 is arranged adjacent to the housing portion 270B of the housing assembly 270 of the electric generator 260, and a second side 276B of the second hub 276 is arranged adjacent to a second side 272B of the nested damper assembly 272.

A stator 282 is arranged concentric to the input shaft 265, between the housing assembly 270 and the nested damper assembly 272.

A rotor assembly 284 is arranged concentric to the input shaft 265, and located between the housing assembly 270 and the nested damper assembly 272.

A resolver ring 286 is arranged concentric to the input shaft 265, and adjacent to a resolver 288. The resolver ring 286 and resolver 288 are arranged between the second hub 276 and the housing portion 270B of the housing assembly 270.

An alternating current (AC) grounding brush 290 is arranged concentric to the input shaft 265, adjacent to second hub 276 opposite the resolver ring 286. The AC grounding brush 290 is placed at an interface between the rotor assembly 284 and a ground (not shown).

Deep groove ball bearings 292A, 292B are arranged between the first hub 274 and the case portion 270A of the housing assembly 270, and the second hub 276 and the housing portion 270B of the housing assembly 270 respectively.

The rotor assembly 284 includes spline connections 284A that connect the AC grounding brush 290 and the deep groove ball bearings 292A, 292B to the housing assembly 270 directing reacting loads from the IC engine 40 to the housing assembly 270.

As illustrated in FIG. 2A, the inverter 278 is configured as a remote inverter. That is, the inverter 278 is located a distance D away from the housing assembly 270 of the electric generator 260, and electrically connected to the housing assembly 270 of the electric generator 260 via alternating current (AC) cabling 280.

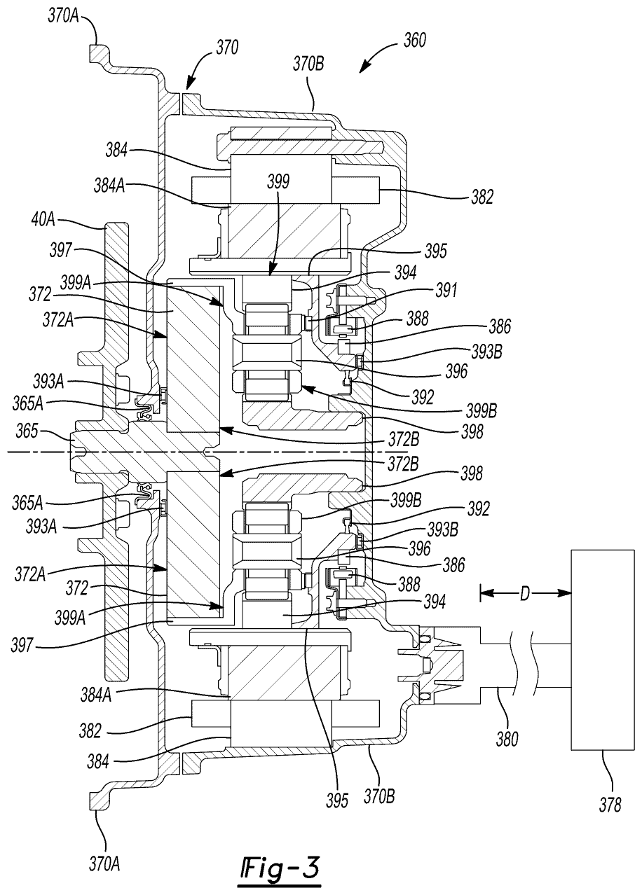

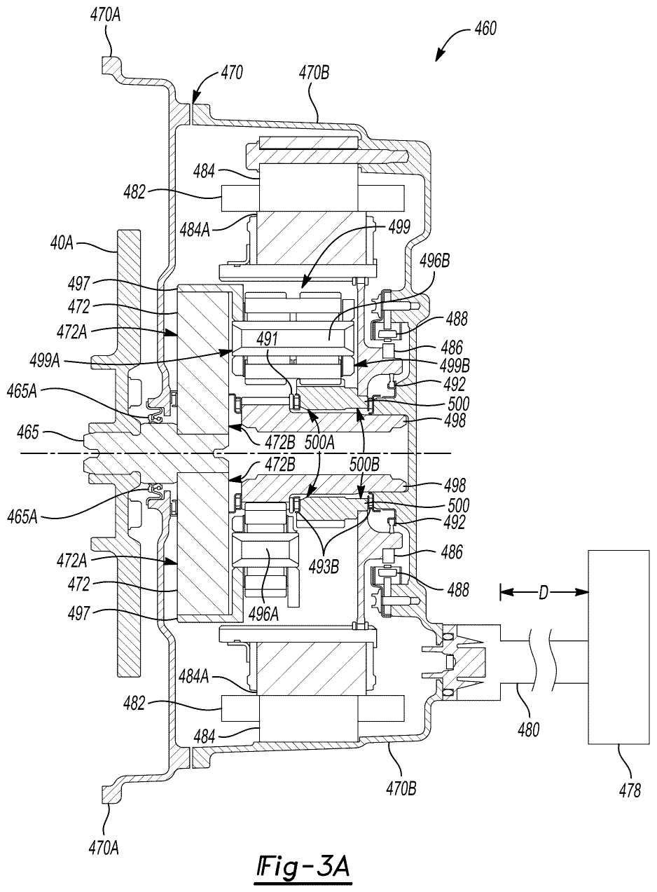

According to one aspect of the disclosure, as illustrated in FIG. 3, an electric generator 360 includes an input shaft 365, a housing assembly 370 having a case portion 370A and a housing portion 370B, a nested damper assembly 372 arranged within the housing assembly 370 and an inverter 378, which is configured as a remote inverter.

The case portion 370A is arranged adjacent to the housing portion 370B. The case portion 370A, the housing portion 370B, and the nested damper assembly 372 are each arranged concentric to the input shaft 365.

A shaft seal 365A is arranged concentric to the input shaft 365 between the input shaft 365 and the case portion 370A of the housing assembly 370 of the electric generator 360.

An engine flange 40A is arranged adjacent to a first face 370A1 of the case portion 370A of the housing assembly 370, and concentric to the input shaft 365.

A planetary gear set 399, which is configured as a simple planetary gear set, is arranged concentric to the input shaft 365. The planetary gear set 399 includes a ring gear 394 arranged concentric to the input shaft 365, a planetary carrier 397 arranged concentric to the input shaft 365, a plurality of planet gears 396 arranged within the planetary carrier 397, a grounded sun gear 398 arranged within the plurality of planet gears 396, and a sun gear flange 395 is arranged adjacent to the housing portion 370B of the housing assembly 370 of the electric generator 360.

A first side 399A of the planetary gear set 399 is arranged adjacent to a second side 372B of the nested damper assembly 372, and a second side 399B of the planetary gear set 399 is arranged adjacent to the housing portion 370B of the housing assembly 370 of the electric generator 360.

A stator 382 is arranged concentric to the input shaft 365, between the housing assembly 370 and the planetary gear set 399.

A rotor assembly 384 is arranged concentric to the input shaft 365, and located between the housing assembly 370 and the planetary gear set 399.

A resolver ring 386 is arranged concentric to the input shaft 365, and adjacent to a resolver 388. The resolver ring 386 and resolver 388 are arranged between the sun gear flange 395 and the housing portion 370B of the housing assembly 370.

An alternating current (AC) grounding brush 390 is arranged concentric to the input shaft 365, adjacent to the sun gear flange 395 opposite the resolver ring 386. The AC grounding brush 390 is placed at an interface between the rotor assembly 384 and a ground (not shown) and/or the grounded sun gear 398.

First and second thrust bearings 393A, 393B are arranged between the case portion 370A of the housing assembly 370 and a first side 372A of the nested damper assembly 372, and the sun gear flange 395 and the housing portion 370B of the housing assembly 370 respectively.

A thrust washer 391 is arranged concentric to the input shaft 365, and between the plurality of planet gears 396 and the sun gear flange 395. The thrust washer 391 may be arranged adjacent to the first thrust bearing 393A or the second thrust bearing 393B as a backing element that acts to insulate the first or second thrust bearing 393A, 393B.

The rotor assembly 384 includes spline connections 384A that connect the AC grounding brush 390 and the first and second thrust bearings 393A, 393B to the housing assembly 370 directing reacting loads from the IC engine 40 to the housing assembly 370.

As illustrated in FIG. 3, the inverter 378 is configured as a remote inverter. That is, the inverter 378 is located a distance D away from the housing assembly 370 of the electric generator 360, and electrically connected to the housing assembly 370 of the electric generator 360 via alternating current (AC) cabling 380.

By including a simple planetary gear set 399, the ring gear 394 can be nested inside of the planetary gear set 399, and integrated or connected to the rotor assembly 384, while the grounded sun gear 398 is connected to the housing assembly 370 to react the planetary gear load increasing a speed ratio from the planetary carrier 397 to the ring gear 394.

According to one aspect of the disclosure, as illustrated in FIG. 3A, an electric generator 460 includes an input shaft 465, a housing assembly 470 having a case portion 470A and a housing portion 470B, a nested damper assembly 472 arranged within the housing assembly 470 and an inverter 478, which is configured as a remote inverter.

The case portion 470A is arranged adjacent to the housing portion 470B. The case portion 470A, the housing portion 470B, and the nested damper assembly 472 are each arranged concentric to the input shaft 465.

A shaft seal 465A is arranged concentric to the input shaft 465 between the input shaft 465 and the case portion 470A of the housing assembly 470 of the electric generator 460.

An engine flange 40A is arranged adjacent to a first face 470A1 of the case portion 470A of the housing assembly 470, and concentric to the input shaft 465.

A planetary gear set 499, which is configured as a compound planetary gear set, is arranged concentric to the input shaft 465. The planetary gear set 499 includes a planetary carrier 497 arranged concentric to the input shaft 465, a first plurality of planet gears 496A and a second plurality of planet gears 496B arranged within the planetary carrier 497, a grounded sun gear 498, a sun gear 500, and a sun gear flange 495 arranged adjacent to the housing portion 470B of the housing assembly 470 of the electric generator 460.

The sun gear 500 is arranged concentric with and adjacent to the grounded sun gear 498 in a meshed configuration.

The first plurality of planet gears 496A is arranged adjacent to the grounded sun gear 498 in a meshed configuration, and the second plurality of planet gears 496B is arranged adjacent to the sun gear 500 in a meshed configuration.

A first side 499A of the planetary gear set 499 is arranged adjacent to a second side 472B of the nested damper assembly 472, and a second side 499B of the planetary gear set 499 is arranged adjacent to the sun gear flange 495, which is arranged adjacent to the housing portion 470B of the housing assembly 470 of the electric generator 460.

A stator 482 is arranged concentric to the input shaft 465, between the housing assembly 470 and the planetary gear set 499.

A rotor assembly 484 is arranged concentric to the input shaft 465, and located between the housing assembly 470 and the planetary gear set 499.

A resolver ring 486 is arranged concentric to the input shaft 465, and adjacent to a resolver 488. The resolver ring 486 and resolver 488 are arranged between the sun gear flange 495 and the housing portion 470B of the housing assembly 470.

An alternating current (AC) grounding brush 490 is arranged concentric to the input shaft 465, adjacent to the sun gear flange 495 opposite the resolver ring 486. The AC grounding brush 490 is placed at an interface between the rotor assembly 484 and a ground (not shown) and/or the grounded sun gear 498.

A first plurality of thrust bearings 493A are arranged between the case portion 470A of the housing assembly 470 and a first side 472A of the nested damper assembly 472, and the second side 472B of nested damper assembly 472 and the grounded sun gear 498.

A second plurality of thrust bearings 493B are arranged at opposing sides 500A, 500B of a sun gear 500.

A thrust washer 491 is arranged concentric to the input shaft 465, and between the first plurality of planet gears 496A and the sun gear flange 495, and the second plurality of planet gears 496B and the sun gear flange 495. The thrust washer 491 may be arranged adjacent to one of the second plurality of thrust bearings 493B as a backing element that acts to insulate the thrust bearing.

The rotor assembly 484 includes spline connection 484A that connect the AC grounding brush 490 and the first and second plurality of thrust bearings 493A, 493B to the housing assembly 470 directing reacting loads from the IC engine 40 to the housing assembly 470.

As illustrated in FIG. 3A, the inverter 478 is configured as a remote inverter. That is, the inverter 478 is located a distance D away from the housing assembly 470 of the electric generator 460, and electrically connected to the housing assembly 470 of the electric generator 460 via alternating current (AC) cabling 480.

Referring back to FIG. 1 with continued reference to FIG. 3A, power from the IC engine 40 is output as engine torque T to the nested damper assembly 472, which transfers the engine torque T to the planetary carrier 497. The grounded sun gear 498 reacts torque from the second plurality of planet gears 496B, which mesh with the first plurality of planet gears 496A to transfer torque to the sun gear 500, which transfers torque to the rotor assembly 484 through the spline connection 484A.

An electrified drive system 100 (FIG. 1) and a vehicle 10 (FIG. 1) including the electric generator 160, 260, 360, 460 discussed above are also disclosed.

By including the nested damper assembly into the electric generator, mass and packaging of the electric generator can be optimized.

By including a simple planetary gear set in addition to the nested damper assembly, the electric generator is operable to increase a speed ratio from the planetary carrier to the ring gear, while optimizing mass and packaging of the electric generator.

By including a compound planetary gear set in addition to the nested damper assembly, the electric generator is operable to increase a speed of the rotor to facilitate a speed match between the internal combustion (IC) engine and the electric machine, while optimizing mass and packaging of the electric generator.

These and other attendant benefits of the present disclosure will be appreciated by those skilled in the art in view of the foregoing disclosure.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. An electric generator, comprising:
an input shaft;
a housing assembly including:
a case portion arranged concentric to the input shaft;
a housing portion arranged concentric to the input shaft; and
a nested damper assembly arranged within the housing assembly of the electric generator, wherein the nested damper is arranged concentric to the input shaft.

2. The electric generator as recited in claim 1, further including:
a first hub arranged concentric to the input shaft, wherein a first side of the first hub is arranged adjacent to the case portion of the housing assembly of the electric generator, and a second side of the first hub is arranged adjacent to a first side of the nested damper assembly; and
a second hub arranged concentric to the input shaft, wherein a first side of the second hub is arranged adjacent to the housing portion of the housing assembly of the electric generator, and a second side of the second hub is arranged adjacent to a second side of the nested damper assembly; and
wherein the nested damper is arranged between the first hub and the second hub.

3. The electric generator as recited in claim 1, further including:
a stator arranged concentric to the input shaft, wherein the stator is located between the housing assembly and the nested damper assembly; and
a rotor assembly arranged concentric to the input shaft, wherein the rotor assembly is located between the housing assembly and the nested damper assembly.

4. The electric generator as recited in claim 1, further including an inverter arranged adjacent to the housing assembly, wherein the inverter is mechanically connected to the housing assembly of the electric generator.

5. The electric generator as recited in claim 1, further including an inverter arranged a distance away from the housing assembly, wherein the inverter is electrically connected to the electric generator via alternating current (AC) cabling.

6. The electric generator as recited in claim 1, further including:
a planetary gear set arranged concentric to the input shaft, the planetary gear set including:
a ring gear arranged concentric to the input shaft;
a planetary carrier arranged concentric to the input shaft;
a plurality of planet gears arranged within the planetary carrier; and
a grounded sun gear arranged within the plurality of planet gears;
a sun gear flange arranged adjacent to the housing portion of the housing assembly; and
wherein a first side of the planetary gear set is arranged adjacent to the nested damper assembly, and a second side of the planetary gear set is arranged adjacent to the sun gear flange.

7. The electric generator as recited in claim 6, further including:
a stator arranged concentric to the input shaft, wherein the stator is located between the housing assembly and the planetary gear set; and
a rotor assembly arranged concentric to the input shaft, wherein the rotor assembly is located between the housing assembly and the planetary gear set.

8. The electric generator as recited in claim 7, further including:
a first thrust bearing arranged between the case portion of the housing assembly and the nested damper assembly; and
a second thrust bearing arranged between the sun gear flange and the housing portion of the housing assembly.

9. The electric generator as recited in claim 8, further including a thrust washer arranged between plurality of planet gears and the sun gear flange.

10. The electric generator as recited in claim 1, further including:
a planetary gear set arranged concentric to the input shaft, the planetary gear set including:
a planetary carrier arranged concentric to the input shaft;
a first plurality of planet gears arranged within the planetary carrier;
a second plurality of planet gears arranged within the planetary carrier;
a grounded sun gear arranged concentric to the input shaft;
a sun gear arranged concentric with the input shaft; and
a sun gear flange arranged adjacent to the housing portion of the housing assembly, wherein the sun gear is arranged concentric with and adjacent to the grounded sun gear; and
wherein a first side of the planetary gear set is arranged adjacent to the nested damper assembly, and a second side of the planetary gear set is arranged adjacent to the housing portion of the electric generator.

11. The electric generator as recited in claim 10, further including:
a stator arranged concentric to the input shaft, wherein the stator is located between the housing assembly and the planetary gear set; and
a rotor assembly arranged concentric to the input shaft, wherein the rotor assembly is located between the housing assembly and the planetary gear set.

12. The electric generator as recited in claim 10, further including:
a first plurality of thrust bearings including one of the first plurality of thrust bearings arranged between the case portion of the housing assembly and the nested damper assembly, and another of the first plurality of thrust bearings arranged between the nested damper assembly and the grounded sun gear; and
a second plurality of thrust bearings including one of the second plurality of thrust bearings arranged at one side of the sun gear and another of the second plurality of thrust bearings arranged at another side of the sun gear.

13. The electric generator as recited in claim 12, further including a thrust washer arranged between the first plurality of planet gears and the sun gear flange, and the second plurality of planet gears and the sun gear flange.

14. An electrified drive system for an electrified vehicle, the electrified drive system comprising:
an internal combustion (IC) engine;
an electric generator driven by the IC engine; and
an electric machine powered by the electric generator, wherein at least one of a plurality of wheel assemblies is driven by the electric machine, and wherein the electric generator includes:
an input shaft;
a housing assembly including:
a case portion arranged concentric to the input shaft;
a housing portion arranged concentric to the input shaft; and
a nested damper assembly arranged within the housing assembly of the electric generator, wherein the nested damper assembly is arranged concentric to the input shaft.

15. The electrified drive system as recited in claim 14, wherein the electric generator further includes:
a first hub arranged concentric to the input shaft, wherein a first side of the first hub is arranged adjacent to the case portion of the housing assembly of the electric generator, and a second side of the first hub is arranged adjacent to a first side of the nested damper assembly;
a second hub arranged concentric to the input shaft, wherein a first side of the second hub is arranged adjacent to the housing portion of the housing assembly of the electric generator, and a second side of the second hub is arranged adjacent to a second side of the nested damper, wherein the nested damper is arranged between the first hub and the second hub;
a stator arranged concentric to the input shaft, wherein the stator is located between the housing assembly and the nested damper assembly; and
a rotor assembly arranged concentric to the input shaft, wherein the rotor assembly is located between the housing assembly and the nested damper assembly.

16. The electrified drive system as recited in claim 15, wherein the electric generator further includes an inverter arranged adjacent to the housing assembly, wherein the inverter is mechanically connected to the housing assembly of the electric generator.

17. The electrified drive system as recited in claim 14, wherein the electric generator further includes:
a planetary gear set arranged concentric to the input shaft, the planetary gear set including:
a planetary carrier arranged concentric to the input shaft;
a first plurality of planet gears arranged within the planetary carrier;
a second plurality of planet gears arranged within the planetary carrier;
a grounded sun gear arranged concentric to the input shaft
a sun gear arranged concentric with the input shaft, wherein the sun gear is arranged concentric with and adjacent to the grounded sun gear, wherein a first side of the planetary gear set is arranged adjacent to the nested damper assembly, and a second side of the planetary gear set is arranged adjacent to the housing portion of the electric generator; and
a stator arranged concentric to the input shaft, wherein the stator is located between the housing assembly and the planetary gear set; and
a rotor assembly arranged concentric to the input shaft, wherein the rotor assembly is located between the housing assembly and the planetary gear set.

18. The electrified drive system as recited in claim 17, wherein the electric generator further includes:
a first plurality of thrust bearings including one of the first plurality of thrust bearings arranged between the case portion of the housing assembly and the nested damper assembly, and another of the first plurality of thrust bearings arranged between the nested damper assembly and the grounded sun gear; and
a second plurality of thrust bearings including one of the second plurality of thrust bearings arranged at one side of the sun gear and another of the second plurality of thrust bearings arranged at another side of the sun gear.

19. The electrified drive system as recited in claim 18, wherein the electric generator further includes a thrust washer arranged between the first plurality of planet gears and the sun gear flange, and the second plurality of planet gears and the sun gear flange.

20. An electrified vehicle comprising:
a vehicle body;
a plurality of wheel assemblies; and
an electrified drive system arranged adjacent to the vehicle body, wherein the electrified drive system includes:
an internal combustion (IC) engine;
an electric generator driven by the IC engine; and
an electric machine powered by the electric generator, wherein at least one of the plurality of wheel assemblies is driven by the electric machine, and wherein the electric generator includes:
an input shaft;
a housing assembly including:
a case portion arranged concentric to the input shaft;
a housing portion arranged concentric to the input shaft; and
a nested damper assembly arranged within the housing assembly of the electric generator, wherein the nested damper assembly is arranged concentric to the input shaft; and
a controller in communication with the electrified drive system, wherein the controller is configured to execute control routines and/or manage operation of the electrified drive system.
